(19) United States
(12) Patent Application Publication
(10) Pub. No.: US 2018/0023545 A1
(43) Pub. Date: Jan. 25, 2018

(54) ROTATING SUNLIGHT/LIGHT BEAM FOR FRACTIONAL/BENEFICIAL USE

(71) Applicant: Jack O'Neal Walden, SR., Tucson, AZ (US)

(72) Inventor: Jack O'Neal Walden, SR., Tucson, AZ (US)

(21) Appl. No.: 15/213,996

(22) Filed: Jul. 19, 2016

(51) Int. Cl. F03D 1/04; F03D 9/25; F03B 11/02; F03B 13/10; H02S 10/12; F03D 9/00; H02K 7/18

(52) U.S. Cl. CPC F03D 1/04; F03D 9/002; F03D 9/25; H02K 7/183; F03B 13/10; H02S 10/12; F03B 11/02; F05B 2240/217; F05B 2240/12; F05B 2220/706

(57) ABSTRACT

This instant utility application Ser. No. 15/213,996 claims the benefit of priority and, is submitted to replace provisional application 62/334/961 which is herein incorporated by reference in its entirety to improve U.S. Pat. No. 8,/710,414. The improvements are:
1. To allow for the creating of kinetic energy by harnessing the fluid power of the wind, with cones as indicated in said U.S. Pat. No. 8,710,414, thereby producing and increasing velocity pressure to drive the compressor in the reverse direction.
2. To allow for the creating of kinetic energy by harnessing the fluid power of the water, with cones as indicated in said U.S. Pat. No. 8,710,414, thereby producing and increasing velocity pressure to drive the compressor in the reverse direction.
3. To allow for attaching a framework on the alt-azimuth telescope type mount as contained in U.S. Pat. No. 8,710,414 to hold photovoltaic cells for the purpose of generating electricity from incident light, such as sunlight.

### SUMMARY OF THE PRESENT INVENTION

It is therefore an object of the present invention to provide improvements to U.S. Pat. No. 8,710,414 by creating kinetic energy from a cone; and, with attaching a framework with photovoltaic cells and directly aiming them at the sun, with a dual axis tracker control.

### HOW IT WORKS

The large opening of the cone is always the entrance and, the small opening is always the exiting end. By forcing a large amount of “fluid” (air/wind or water) to compress or, attempt to compress, a velocity pressure is created to power the various respected compressors. The “compressors” can be fan blades, blower wheels, centrifugal impellers, rotary blades, e.g., any type, including piston driven compressors with modified valves.

### DETAILED DESCRIPTION OF THE PREFERRED EMBODIMENT

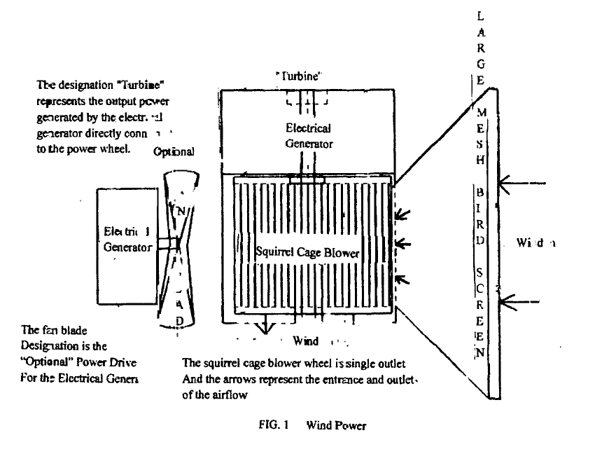

In reference to the FIG. 1 drawing, wind power, in addition to using others' directional controls, it might be best to utilize the counter weight, in the shape of a rudder, like on a boat, ship or, airplane filled with fluid. This would be the stabilizer and could be heated and, used to keep everything from freezing. The “fan blade” part of the drawing is to show it as a substitute for the blower wheel.

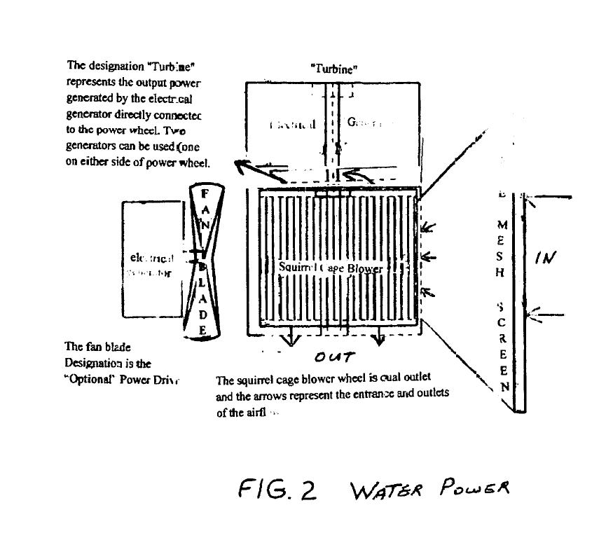

In reference to the FIG. 2 drawing, water power, in addition to using others' directional controls, it might be best to utilize the standard rudder or, to fasten it to a secure place.

In reference to the FIG. 2 drawing, water power, when used for tidal flows, the cone would be anchored to the sea bed, either on the bottom side or on the two sides and would change directions with the attaching of a buoy to the small end of the cone. The cable attachments are with swivel connectors and, the buoys will rotate or turn over the cones with the tidal flows.

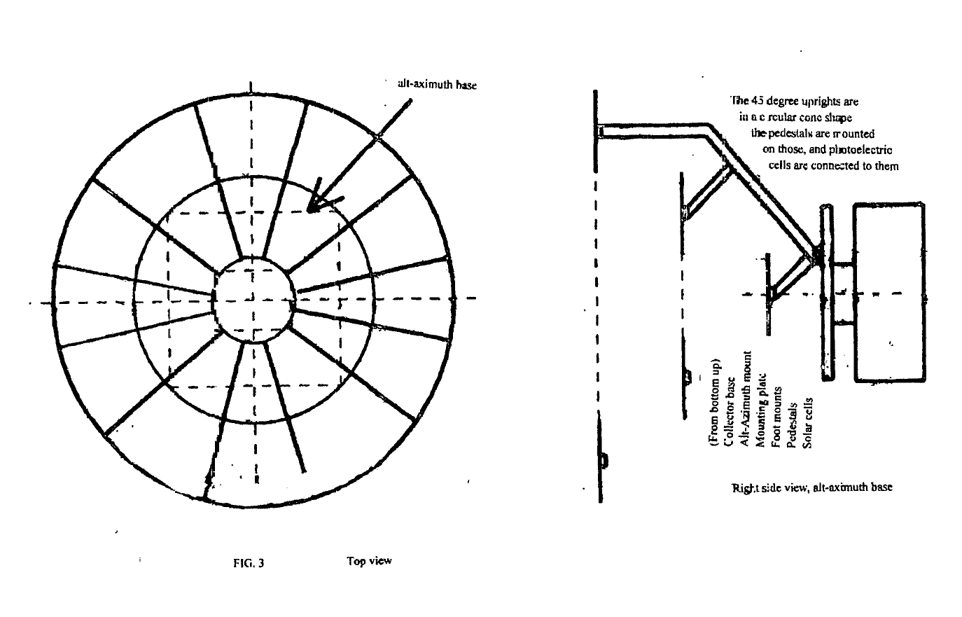

In reference to the FIG. 3 drawing, in addition to using others' directional controls, it might be best to utilize the counter weight, in the shape of a rudder, filled with fluid. This would be the stabilizer and could be heated and, used to keep everything from freezing.

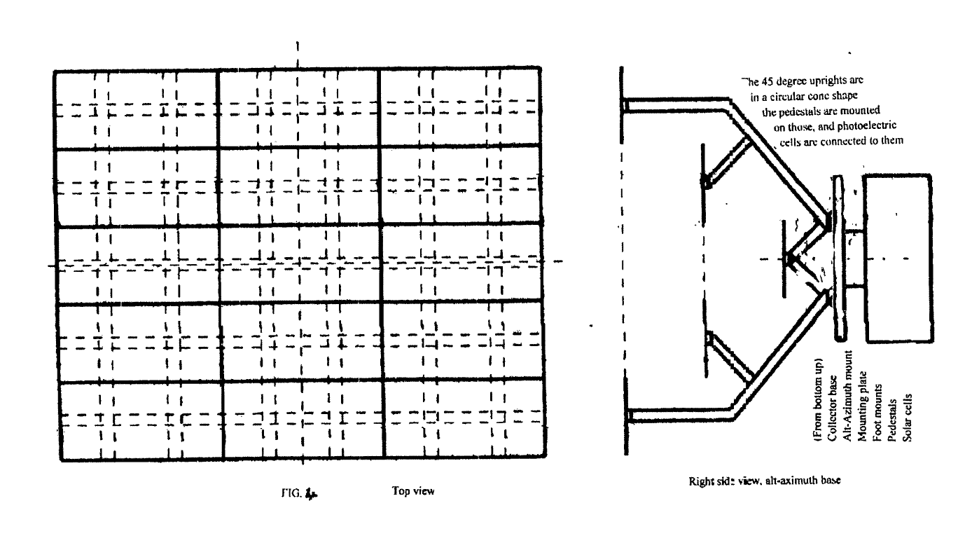

In reference to the FIG. 4 drawing, in addition to using others' directional controls, it might be best to utilize the counter weight, in the shape of a rudder, filled with fluid. This would be the stabilizer and could be heated and, used to keep everything from freezing. FIG. 4, right side page 2 is a representation of the alt-azimuth telescope type mount as contained in U.S. Pat. No. 8,710,414.

What is claimed is:

1. A method for creating electric power by utilizing Water to drive the generator.

2. A method for creating electric power by utilizing Wind to drive the generator.

3. A method for creating electric power by attaching solar panels to the collector.
